(19) United States
(12) Patent Application Publication
(10) Pub. No.: US 2005/0160040 A1
(43) Pub. Date: Jul. 21, 2005

(54) Conditional access system and apparatus

(76) Inventors: Bartholomeus Johannes Van Rijnsoever, Eindhoven (NL); Franciscus Lucas Antonius Johannes Kamperman, Eindhoven (NL); Albert Maria Arnold Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,366

(22) PCT Filed: Apr. 3, 2003
(86) PCT No.: PCT/IB03/01404

(30) Foreign Application Priority Data
Apr. 19, 2002 (EP) 02076548.3

(51) Int. Cl. H04L 9/00

(52) U.S. Cl. 705/50

(57) ABSTRACT

A signal (24) that contains a stream of encrypted data and a plurality of individually identified streams (20, 22) of messages. Each of the streams (20, 22) of messages contains decryption information for decrypting a common part of the encrypted data. In a receiving and recording apparatus a mode selection unit (16) selects an operating mode from a plurality of modes including a live rendering mode and a replay mode for rendering the signal with a rendering unit (14) when received live and when replayed from storage respectively. A decoder (14) decrypts the encrypted data using a selectable one of the streams of messages. The decoder (14) selects the stream of messages dependent on the selected operating mode.

The invention relates to a conditional access apparatus and a method of providing conditional access.

MPEG transport streams provide for conditional access. These streams contain encrypted data and messages that enable the decryption of the encrypted data. The messages include so-called ECM's (Entitlement Control Messages) that contain control words for decrypting the encrypted data. The control words are continuously updated, making it necessary to include a stream of ECM's with the encrypted data. The control words in the ECM's themselves are encrypted using an authorization key. The messages also include so-called EMM's (Entitlement Management Messages) that contain the authorization keys. The EMM's are encrypted with user specific keys. This means that different EMM's have to be broadcast for different users. As a result an EMM for a specific user can only be broadcast infrequently.

Conditional access allows a service provider to broadcast media information in such a way that only authorized users (paying subscribers) are able to decrypt the encrypted data. To do so the service provider provides each user with a receiving device. The receiving device contains a secure device that is capable of decrypting the EMM's for the user, so as to allow the receiving device to decrypt the ECM's broadcast by the service provider and thereby in turn to decode the encrypted data. The service provider strongly protects the secure device (typically a smart card) against tampering, such as illegal access to obtain copies of the key that is needed to decrypt the EMM's.

Different service providers typically each operate their own system, each with its own provider specific decoders, secure devices and broadcast channels. Mixing the systems involves the risk of compromising access security. For example, if different service providers would supply authorization keys under different conditions the subscribers could manipulate authorization key selection. Since EMM's can only be broadcast infrequently any error in the supply of authorization keys can only be corrected after a relatively long time. However the security of using separate systems is inefficient for example in terms of bandwidth usage. Double bandwidth is needed when different service providers broadcast the same information to their respective subscribers, for example when the service providers service in different area's that are capable of receiving the same signal.

To improve the efficiency without any long term risk of less security it has been known to broadcast a single stream of encrypted data accompanied with a plurality of streams of messages, each from a different service provider, each stream containing ECM's and EMM's for decrypting the encrypted data. Thus, the subscribers of all of the service providers are enabled to decrypt the same encrypted data. At the same time security need not be compromised because each service provider provides the control words with his own ECM's. Any lapse in security is corrected by the next change of control word, which occurs typically every 10 seconds.

It is increasingly becoming cost effective for subscribers to provide conditional access devices with storage devices such as hard disks for storing conditionally accessible information. The storage device can be used for time-shifted viewing and for multiple viewing. Such use adds additional value to the conditional access device and therefore it would be desirable that the service provider could exercise control over replay. Replay also leads to difficulties, for example when the authorization key is changed between the time when the encrypted data and the ECM's are stored and the time when they are replayed. This means that the authorization key has to be changed back to an old authorization key.

Amongst others, it is an object of the invention to allow service providers to exercise a more flexible control over conditional access.

The invention provides for an apparatus as set forth in claim 1. According to the invention a signal with a plurality of streams of messages with decryption information for the same encrypted data is used. The apparatus provides access to the encrypted data using different streams of messages in different modes of operation. For example, one stream of messages may be used to decrypt the data during live rendering of the data and another stream of messages may be used to decrypt the same data during rendering of a replayed signal. Yet another stream of messages may be used during transcoding, when the apparatus decrypts the same data in order to reduce its compression rate.

The service provider broadcasts the signal with the encrypted data and a plurality of streams of messages with decryption information, so that each stream of messages can be used independently of the other to decrypt the data. Each decryption device is authorized to decrypt the data with one of a set of possible authorizations, which includes one or more authorizations to use messages from any one of a combination of streams that is particular to the device. Preferably the set also includes authorizations to use a single stream, for live replay for example. Authorization is realized by supplying the relevant authorization keys, for example in EMM's, but also possibly via additional channels such as via the internet. Thus, one device may be authorized for example to use only the stream of messages used in the live rendering mode, allowing the device only to perform live rendering only. Another device may be authorized to use the stream for live rendering and the stream for replay, allowing the device to perform both modes of rendering.

The service provider may use different time points to change the authorization of the use of different ones of the streams of messages. The authorization of messages for the replay mode for example may be for signals broadcast during a certain period, while the authorization of messages for the live rendering mode are regularly replaced.

These and other advantageous aspects of the apparatus and method according to the invention will be described in more detail using the following figures.

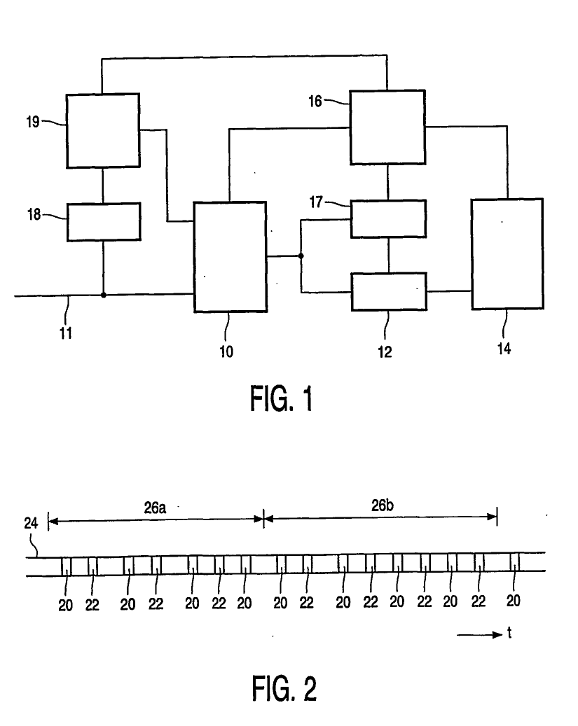

FIG. 1 shows an apparatus for providing conditional access to encrypted data;

FIG. 2 illustrates a signal with a plurality of streams of messages;

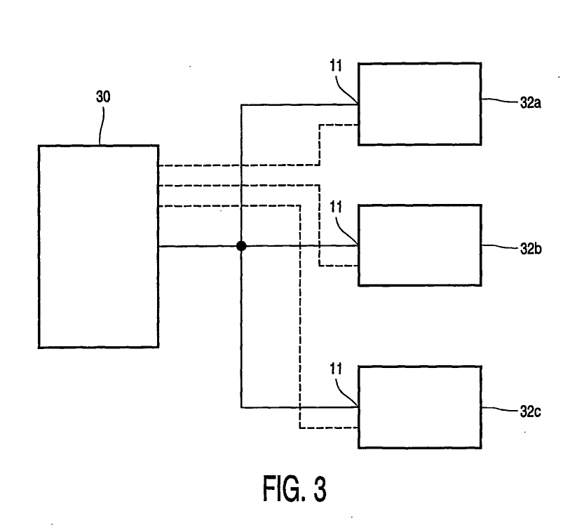

FIG. 3 shows a signal distribution system.

FIG. 1 shows an apparatus for providing conditional access to encrypted data. The apparatus has an input 11 for receiving a signal that contains the encrypted data, a multiplexer 10, a data decoder 12 and a rendering unit 14 coupled in cascade. Furthermore the apparatus contains a mode selection unit 16, a secure device 17, a recording preprocessor 18 and a storage device 19. The mode selection unit 16 is coupled to control inputs of secure device 17, multiplexer 10, storage device 19, and rendering unit 14. Secure device 17 is coupled to an output of multiplexer 10 together with data decoder 12. Secure device 17 has a control word output coupled to a control word input of data decoder 12. Input 11 is coupled to storage device 19 via storage pre-processor 18. Storage device 19 has a replay output coupled to multiplexer 10.

In operation the apparatus processes conditional access signals such as MPEG streams. Data decoder 12 and secure device 17 together operate as a conditional access decoder that is capable of decrypting data from the signal, provided that an appropriate authorization key is present en entitled to be used in secure device 17. The apparatus operates in a selectable one of a number of operating modes. Mode selection unit 16 selects the operating mode and instructs the remainder of the apparatus to operate in the selected mode. Two operating modes will be illustrated: a live rendering mode and a replay mode.

In the live rendering mode a signal received at input 11 is passed to data decoder 12 by multiplexer 10. Data decoder 12 decrypts data from the signal and passes the decrypted data to rendering device 14. Rendering device 14 contains for example a display screen to display video data if the encrypted data represents a video signal. In the live rendering mode, mode selection unit 16 commands multiplexer 10 to pass the signal from input 11 to data decoder 12 and secure device 17. Mode selection unit 16 commands secure device 17 to extract decryption information from messages for live rendering from the signal and secure device 17 passes control words obtained from the messages to data decoder 12 to decode the encrypted data from the signal.

In the replay mode a signal stored in storage device 19 is retrieved and passed to data decoder 12 by multiplexer 10. Data decoder 12 decrypts data from the signal and passes the decrypted data to rendering device 14. In the replay mode, mode selection unit 16 commands multiplexer 10 to pass the signal from storage device 19 to data decoder 12 and secure device 17. Mode selection unit 16 commands storage device 19 to replay the data, mode selection unit 16 commands multiplexer 10 to pass data from storage device 19 and mode selection unit 16 commands secure device 17 to extract decryption information from messages for replay from the signal. Secure device 17 passes control words obtained from the messages to data decoder 12 to decode the encrypted data from the signal.

FIG. 2 illustrates a signal 24 as received at input 11. The signal is for example an MPEG transport stream. The signal contains encrypted data and messages 20, 22 with decryption information (for example ECM's: Entitlement Control Messages). The signal progresses as a function of time, shown from left to right. Time is divided into successive time intervals 26a,b. In each time interval 26a,b the encrypted data is encrypted in a different way and data decoder 12 needs a different control word to decrypt the data from each time-interval respectively. In an MPEG transport stream for example the time intervals last typically 10 seconds. The control words are included in messages 20, 22 in signal 24. In principle a plurality of messages with the same control word (or control words) is included in the stream for each time interval 26a,b (the number of messages is only shown symbolically, in an MPEG stream for example an ECM is transmitted approximately every 0.1 second). More particularly, each ECM contains two control words, one control word for decrypting current data and a next future control word for decrypting data after the next change of control word. The data is accompanied by indicators to indicate which control word should be used.

The control words in the messages 22, 24 are encrypted. Secure device 17 decrypts the control words from part of the messages 22, 24 and supplies the currently needed decrypted control words to data decoder 12 to control decoding of the encrypted data from the signal. The control word supplied by secure device 17 changes at the start of each new time interval 26a,b in which a new control word is needed.

FIG. 2 shows a plurality of streams of messages 20, 22 with the same control words. A first stream contains first messages 20 and a second stream contains second messages 22. Each particular stream corresponds to a different authorization key that is needed to decrypt the control words from the messages 20, 22 in the particular stream. Any one of the streams of messages 20, 22 on its own suffices to decrypt the control words for decrypting the encrypted data. Mode control unit 16 instructs secure device 17 as to which stream of messages 20, 22 should be used, dependent on the selected operating mode. In the live rendering mode for example the first stream of messages 20 may be used and in the replay mode the second stream of messages 22 may be used, provided that the corresponding authorization key is present and entitled in secure device 17. Thus, each operating mode is enabled by possession of a different authorization key in secure device 17.

Secure device 17 may use any way to select the appropriate messages from the signal. In one embodiment each message with decryption information contains an identifier to indicate the stream to which the message belongs. In this case, secure device needs only to decrypt control words from the messages the carry the identifier of the stream that is selected for the mode indicated by mode selection unit 16.

Mode control unit preferably has a user interface (not shown) for selecting the operating mode. In addition the user interface may be used to command storage of a signal received at input 11 in storage device 19. In this case the signal may be pre-processed, for example by removing the messages 20 for the stream of messages that are intended for use during live rendering. Thus, tamper resistance is improved, by ensuring that the messages with decryption information for decrypting live streams are absent altogether from stored streams.

Although the invention has been illustrated in terms of a live rendering mode and a replay mode, additional modes may be used without deviating from the invention. Some of these modes may use the same stream of messages as another one of the modes, or they may use a different stream of messages (not shown in FIG. 2). For example, the apparatus may have a transcoding mode for a compressed video stream, such as an MPEG signal in which the encrypted data is decoded and the decoded data is transcoded, e.g. to convert the data to a lower bit rate at a higher compression ratio. In this case a transcoding unit may be part of rendering device 14, for example in the form of a computer program, or it may be part of storage device 19 or it may be provided separately. Selection unit 16 commands the transcoding unit to transcode the data and at the same time commands secure device 17 to use decryption information from a stream of messages that is associated with transcoding.

Furthermore, although the invention has been illustrated using a multiplexer and a secure device which are controlled in common by the same control device, so that ECM selection and source selection are performed in common, it will be understood that such common control is not essential. The secure device may use detection of the presence or absence of a specific stream of messages with decryption information to select an appropriate stream of messages. That is, it need not be directly controlled by the same control device as the multiplexer. For example, when messages with decryption information for decryption “live” streams are not stored with the stream, secure device may automatically select messages with decryption information for stored streams, if entitled to do so, when it receives information that is apparently stored information because it lacks a stream of messages with decryption information for “live” reception”.

FIG. 3 shows a signal distribution system with a distribution unit 30 and a plurality of apparatuses 32a-c of the type shown in FIG. 1. The distribution unit 30 is coupled to the inputs 11 of the apparatuses 32a-c via a broadcast channel. In addition the distribution unit has couplings to the secure devices (not shown) in the respective apparatuses. These couplings may be temporary couplings via telephone lines or via the Internet.

In operation the distribution system makes use of the fact that the apparatuses 32a-c use different streams of messages to obtain the control words for operation in different modes. Distribution unit 30 provides each apparatus 32a-c with its own specific combination of authorization keys to decrypt different streams of messages 20, 22 and thereby to operate in different modes. Thus different subscribers, using different ones of the apparatuses 30a-c may be enabled to operate different modes dependent on the payment of subscriber fees. The authorization key for replay from storage might be provided specifically on demand when the subscriber wants to view stored data.

1. An apparatus for processing a signal that contains a stream of encrypted data and a plurality of individually identified streams of messages, each of the streams of messages containing decryption information for decrypting a common part of the encrypted data, the apparatus comprising
an input for the signal;
a storage device for storing and retrieving the signal or part of the signal;
a rendering unit;
a mode selection unit arranged to select an operating mode from a plurality of modes including a live rendering mode and a replay mode for rendering the signal with the rendering unit when received from the input and when retrieved from the storage device respectively;
a decoder for decrypting the encrypted data using a selectable one of the streams of messages, if entitled to use said selectable one of the streams, the decoder selecting the stream of messages dependent on the selected operating mode.

2. An apparatus according to claim 1, the storage device being arranged to block out from the signal, during storage of the signal, at least one of the streams of messages other than the stream of messages that the decoder selects in the replay mode.

3. An apparatus according to claim 2, the decoder being arranged to detect the selected operating mode from the presence or absence of the at least one of the streams that is blocked out from the signal during storage.

4. An apparatus according to claim 1, wherein the apparatus comprises a transcoder, the plurality of modes including a transcoding mode, the apparatus being arranged to transcode the signal when the mode selection unit selects the transcoding mode.

5. A method of distributing a signal that contains a stream of encrypted data, the method comprising
including a plurality of individually identified streams of messages with the stream, each of the streams of messages containing decryption information for decrypting a common part of the encrypted data;
distributing authorization information to receivers of the stream, providing each receiver with a selected authorization, the authorizations being selected from a set of authorizations that includes at least one authorization to use combinations of the streams of messages to decode the encrypted data, the authorization being selected depending on availability in the receiver of respective entitlements for respective ones of the authorizations.

6. A signal distribution system, for distributing a signal that contains a stream of encrypted data, the system comprising
a signal assembly unit that is arranged to include a plurality of individually identified streams of messages with the stream, each of the streams of messages containing decryption information for decrypting a common part of the encrypted data;
a transmission unit for broadcasting the assembled signal;
an authorization information distribution unit, for distributing authorization information to receivers of the stream, providing each receiver with a selected authorization, the authorizations being selected from a set of authorizations that includes at least one authorization to use combinations of the streams of messages to decode the encrypted data, the authorization being selected depending on availability in the receiver of respective entitlements for respective ones of authorizations.
